(19) United States
(12) Patent Application Publication
(10) Pub. No.: US 2011/0057633 A1
(43) Pub. Date: Mar. 10, 2011

(54) Load driving circuit

(75) Inventor: Tsuyoshi Tanabe, Kanagawa (JP)

(73) Assignee: Renesas Electronics Corporation, Kawasaki (JP)

(21) Appl. No.: 12/923,116

(22) Filed: Sep. 2, 2010

(30) Foreign Application Priority Data
Sep. 7, 2009 (JP) 2009-205819

(51) Int. Cl. G05F 1/46

(52) U.S. Cl. 323/265

(57) ABSTRACT

Provided is a circuit capable of further reducing noise that increases along with an amplitude of a flow-through current flowing through a charge pump circuit. A load driving circuit includes: an output MOS transistor 32 connecting a power supply 30 and a load 31; a charge pump circuit 40 boosting a voltage of the power supply 30 and supplying a boosted voltage to a gate of the output MOS transistor 32; a detection circuit 112 detecting a voltage difference between the voltage of the power supply 30 and a gate voltage of the output MOS transistor 32; and a variable current source 113 controlling a power supply current (flow-through current) flowing through the charge pump circuit 40 based on the voltage difference.

### TECHNICAL FIELD

### Reference to Related Application

This application is based upon and claims the benefit of the priority of Japanese patent application No. 2009-205819, filed on Sep. 7, 2009, the disclosure of which is incorporated herein in its entirety by reference thereto.

The present invention relates to a load driving circuit, and in particular, to a load driving circuit including a charge pump circuit.

### BACKGROUND

A load driving circuit including an output transistor supplying a current to a load and a control circuit controlling on/off of the output transistor is known. When the output transistor is an N-channel transistor, the load driving circuit includes a charge pump circuit applying a voltage to a gate of the output transistor to fully turn on the output transistor (fully on). The charge pump circuit functions as a high side switch (see Patent Document 1) that carries out a source follower operation.

FIG. 7 is a block diagram of a load driving circuit including a charge pump circuit disclosed in Patent Document 1. In FIG. 7, a positive terminal (power supply voltage Vcc) of a power supply 30 is connected to one end of a load 31 via an N-channel power metal oxide semiconductor field effect transistor 32 (hereinafter referred to as MOSFET 32) as an output transistor. A negative terminal of the power supply 30 and the other end of the load 31 are connected to the ground. The load driving circuit includes a charge pump circuit 40 to turn on the MOSFET 32, and the charge pump circuit 40 applies a voltage higher than the power supply voltage Vcc to a gate of the MOSFET 32.

The charge pump circuit 40 has a negative-side power supply connected to a floating node 51 and is connected to the ground via a constant current source 53. A Zener diode 54 is connected as a voltage regulator between a node 49 arranged on the positive terminal side of the charge pump circuit 40 and the floating node 51.

A switch 47 is connected between the node 49 and the positive terminal of the power supply 30 for connection/disconnection therebetween. A switch 48 is connected between the gate of the MOSFET 32 and the ground for connection/disconnection therebetween.

FIG. 8 is a block diagram illustrating a detailed configuration of the charge pump circuit 40. The charge pump circuit 40 includes an oscillation circuit 41, an inverter buffer 42 (hereinafter simply referred to as buffer 42), a capacitor 44, and diodes 45 and 46. An output of the oscillation circuit 41 is connected to one end of the capacitor 44 via the buffer 42 (output node 43). The other end of the capacitor 44 is connected to a cathode of the diode 45 and an anode of the diode 46. The other end of the capacitor 44 is also connected to the power supply 30 via the diode 45 and to the gate of the MOSFET 32 via the diode 46.

Next, an operation of the charge pump circuit 40 will be described. When the output node 43 connected to the buffer 42 outputting an oscillate signal is at a low potential (L), the capacitor 44 is charged up to the power supply voltage Vcc via the diode 45. When the output node 43 connected to the buffer 42 is at a high potential (H), the capacitor 44 releases stored charges to the gate of the MOSFET 32 via the diode 46. This discharge increases a gate voltage of the MOSFET 32 to 2 Vcc stepwise and turns on the MOSFET 32.

To turn off the MOSFET 32, the switch 48 is closed and the gate voltage of the MOSFET 32 is decreased to a ground potential. Further, the switch 47 is opened to disconnect the node 49 from the power supply 30. In this way, the power supply to the charge pump circuit 40 is stopped.

The charge pump circuit 40 is connected to the ground via the constant current source 53, and a power supply current (flow-through current) flows through the charge pump circuit 40 during a boost (pull up) operation. Since the load driving circuit includes the constant current source 53, the charge pump circuit 40 generates less noise during an operation, compared with when the load driving circuit does not include the constant current source 53.

Patent Document 1:

Japanese Patent Kokai Publication No. JP-H08-336277 A

### SUMMARY

Analysis will be hereinafter made based on the view of the present invention.

Since the charge pump circuit 40 of FIG. 8 includes the oscillation circuit 41, a clock signal or the like generated by the oscillation circuit 41 fluctuates the power supply current (flow-through current) flowing through the oscillation circuit 41 and the buffer 42 included in the charge pump circuit 40. Such fluctuation of the flow-through current causes noise that adversely affects peripheral circuits. Thus, the load driving circuit including the charge pump circuit 40 is required to reduce such noise further. The noise is reduced by the presence of the constant current source 53; however, by including the constant current source 53 alone, it is difficult to further reduce the noise that increases along with an amplitude of the flow-through current. Thus there is much to be desired in the art.

The present inventor focused attention on the fact that the conventional charge pump circuit 40 always carries out a constant boost operation regardless of an operating state of the MOSFET 32. Namely, the present inventor focused attention on the fact that, since the boost operation is constant, the flow-through current is also constant irrespective of whether the MOSFET 32 is in a turning-on phase or a fully-on phase.

As a result, the present inventor concluded that it is not problematic if the charge pump circuit 40 carries out different boost operations depending on an operating state of the MOSFET 32 (turning-on phase or fully-on phase). Namely, when the MOSFET 32 has a large gate capacitance (approximately several dozen nF), in a turning-on phase, a sufficient boost operation is required. On the other hand, in a fully-on phase, a boost operation necessary to compensate for leakage from the gate is needed. Thus, it is not problematic if the charge pump circuit 40 carries out a reduced boost operation in a fully-on phase, compared with when at the turning-on phase. Thus, the present inventor concluded that the noise in the fully-on phase can be reduced.

According to one aspect of the present invention there is provided a load driving circuit that includes: an output transistor connecting a power supply and a load; a charge pump circuit boosting a voltage of the power supply and supplying a boosted voltage to a gate of the output transistor; a detection circuit detecting a voltage difference between the voltage of the power supply and a gate voltage of the output transistor; and a variable current source controlling a power supply current flowing through the charge pump circuit based on the voltage difference.

The meritorious effects of the present invention are summarized as follows.

According to the present invention, since a power supply current flowing through a charge pump circuit is controlled based on a voltage difference between a voltage of a power supply and a gate voltage of an output transistor, noise can be reduced further.

### BRIEF DESCRIPTION OF THE DRAWINGS

FIG. 1 is a block diagram of a load driving circuit according to a first example of the present invention.

FIG. 2 is a block diagram specifically illustrating an example of a detection circuit and an example of a variable current source.

FIG. 3 illustrates an example of current characteristics of a P-channel depletion type MOSFET.

FIG. 4A illustrates a flow-through current and a noise waveform (comparative example) according to a conventional technique, and FIG. 4B illustrates a flow-through current and a noise waveform according to an example of the present invention.

FIG. 5 is a block diagram of a load driving circuit according to a second example of the present invention.

FIG. 6 is a block diagram of a load driving circuit according to a third example of the present invention.

FIG. 7 is a block diagram of a conventional load driving circuit.

FIG. 8 is a block diagram illustrating a detailed configuration of a conventional charge pump circuit.

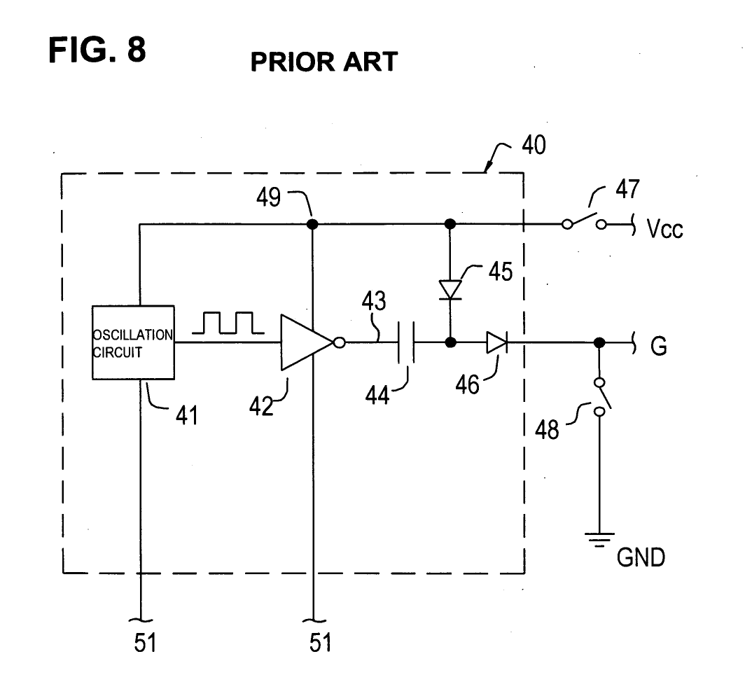

### PREFERRED MODES

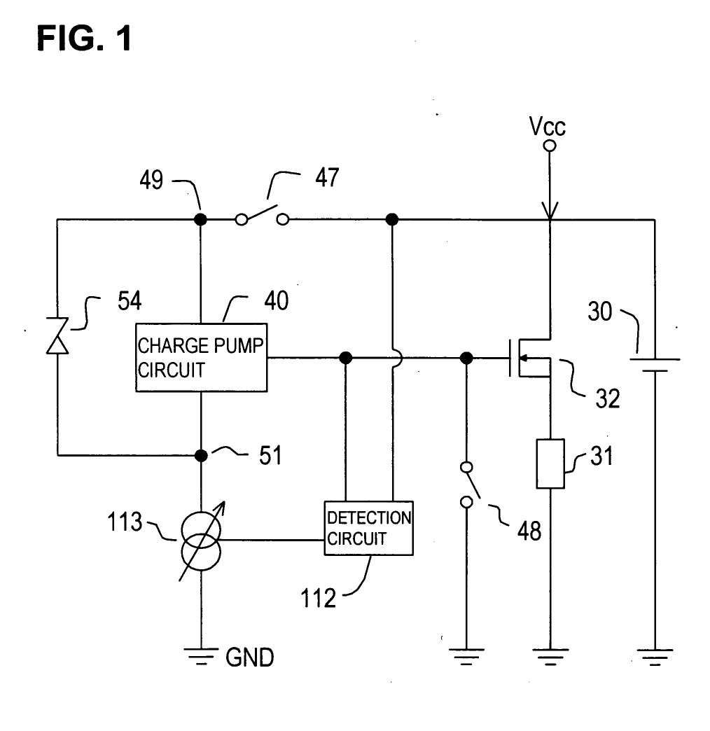

A load driving circuit according to an exemplary embodiment of the present invention includes: an output transistor (32 in FIG. 1) connecting a power supply (30 in FIG. 1) and a load (31 in FIG. 1); a charge pump circuit (40 in FIG. 1) boosting a voltage of the power supply and supplying a boosted voltage to a gate of the output MOS transistor; a detection circuit (112 in FIG. 1) detecting a voltage difference between the voltage of the power supply and a gate voltage of the output transistor; and a variable current source (113 in FIG. 1) controlling a power supply current flowing through the charge pump circuit based on the voltage difference.

Based on the load driving circuit according to the exemplary embodiment of the present invention, it is preferable that the output MOS transistor be transistor of N-channel type or a transistor of the first conductivity type, the same being applied htereinafter). It is also preferable that, when the detection circuit detects that the gate voltage of the output transistor exceeds the voltage of the power supply by a predetermined value, the variable current source reduce the power supply current.

Based on the load driving circuit according to the exemplary embodiment of the present invention, it is preferable that, when the power supply current is reduced, the charge pump circuit reduce a boost operation. It is also preferable that, when the power supply current is increased, the charge pump circuit activate a boost operation.

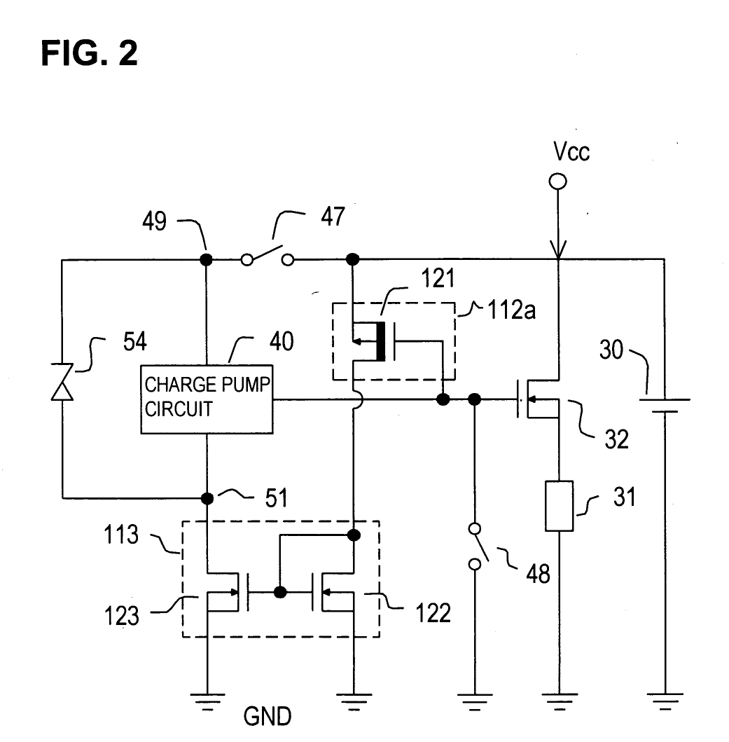

Based on the load driving circuit according to the exemplary embodiment of the present invention, it is preferable that the detection circuit comprise a PMOS transistor (or a MOS transistor of the second conductivity, the same applied hereinafter) (121 in FIG. 2) having a source connected to the power supply, a gate connected to the gate of the output transistor, and a drain connected to one end of the variable current source connect. It is also preferable that the variable current source comprise a current mirror circuit (corresponding to 122 and 123 in FIG. 2) having one end connected to the drain of the PMOS transistor and the other end connected to the charge pump circuit.

Based on the load driving circuit according to the exemplary embodiment of the present invention, it is preferable that the PMOS transistor be a depletion type transistor.

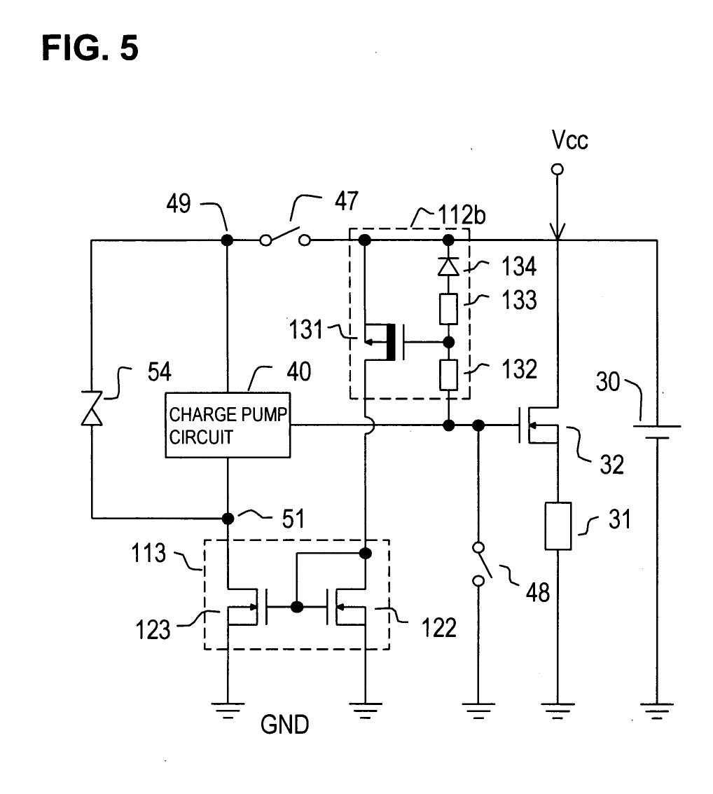

Based on the load driving circuit according to the exemplary embodiment of the present invention, it is preferable that the detection circuit further comprise: a first resistive element (132 in FIG. 5) between the gate of the PMOS transistor and the gate of the output transistor; and a series circuit comprising a diode (134 in FIG. 5) forward biased when a current flows from the gate of the PMOS transistor to the power supply and a second resistive element (133 in FIG. 5) between the gate of the PMOS transistor and the power supply.

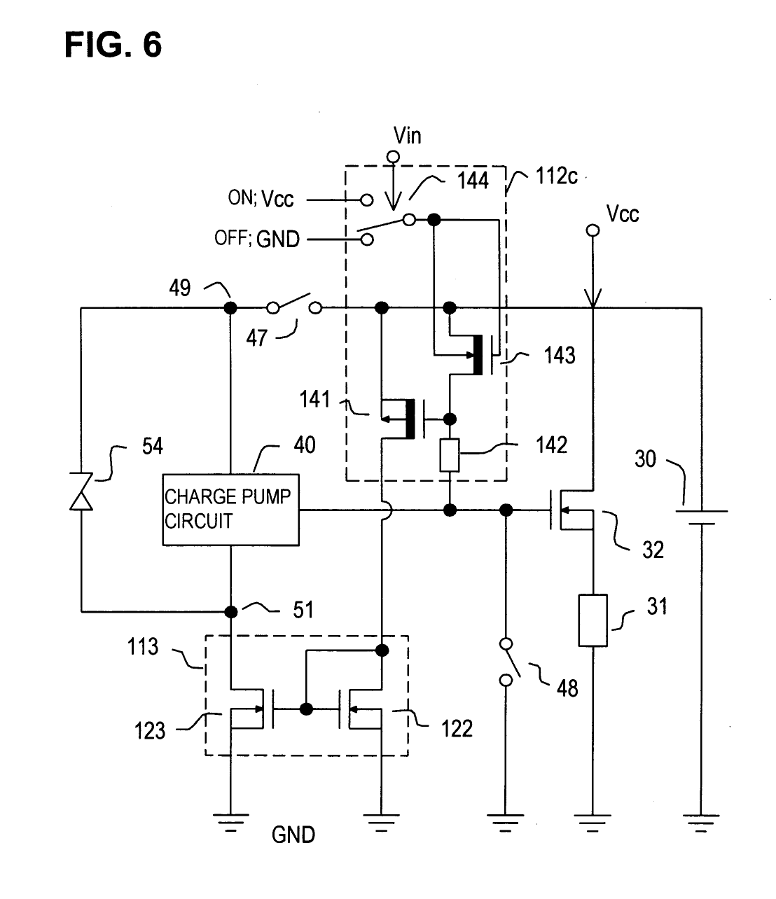

Based on the load driving circuit according to the exemplary embodiment of the present invention, it is preferable that the detection circuit further comprise: a first resistive element (142 in FIG. 6) between the gate of the PMOS transistor and the gate of the output transistor; a detection and control NMOS transistor (143 in FIG. 6) between the gate of the PMOS transistor and the power supply; and a switch (144 in FIG. 6) connecting a gate of the detection and control NMOS transistor to the power supply or the ground.

Based on the load driving circuit according to the exemplary embodiment of the present invention, it is preferable that the detection and control NMOS transistor be a depletion type transistor.

Based on the above load driving circuit, when the output transistor is brought in a fully-on phase, the charge pump circuit reduces an unnecessary boost operation. Thus, a flow-through current flowing through the charge pump circuit in a fully-on phase can be reduced compared with that in an off-state, and accordingly, noise can be reduced further.

Examples of the present invention will be hereinafter described in detail with reference to the drawings.

### Example 1

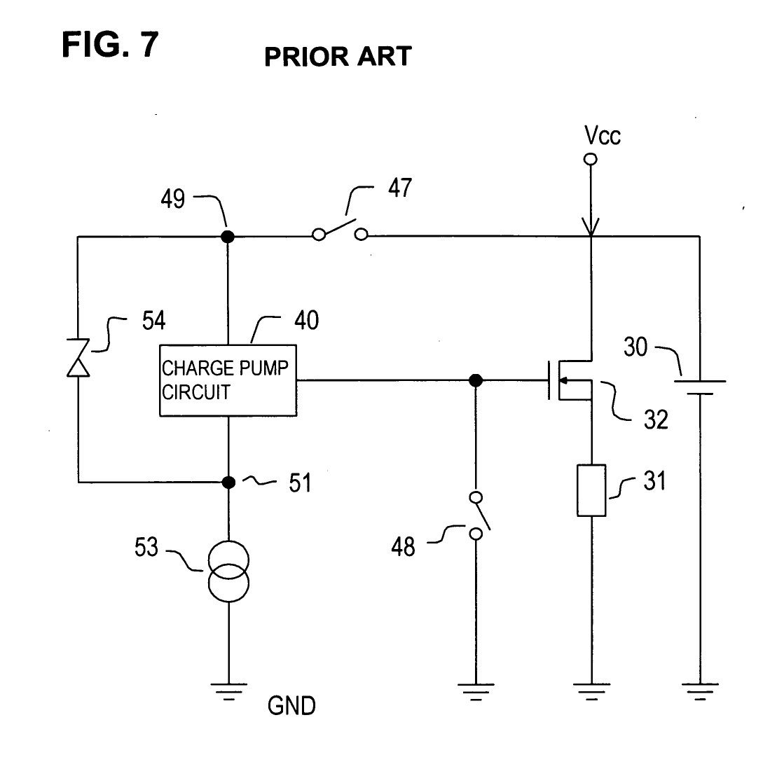

FIG. 1 is a block diagram of a load driving circuit according to a first example of the present invention. In FIGS. 1 and 7, identical reference characters denote identical elements, and the description thereof will be omitted. The load driving circuit of FIG. 1 includes a detection circuit 112 detecting a voltage difference ΔV between the power supply voltage Vcc and a gate voltage of the MOSFET 32 (output transistor) and outputting an output current based on the voltage difference ΔV. Further, the load driving circuit includes a variable current source 113, instead of the constant current source 53 of FIG. 7. The variable current source 113 is arranged between the charge pump circuit 40 and the ground and controls a flow-through current flowing through the charge pump circuit 40.

The detection circuit 112 has one input terminal connected to the power supply voltage Vcc of the power supply 30 and the other input terminal connected to the gate of the MOSFET 32. The detection circuit 112 outputs an output current to the variable current source 113 based on the voltage difference ΔV between the power supply voltage Vcc and the gate voltage of the MOSFET 32. The variable current source 113 receives the output current from the detection circuit 112 and changes the flow-through current flowing through the charge pump circuit 40, so as to reduce a boost operation of the charge pump circuit 40.

More specifically, when the MOSFET 32 is in a triode operation region (fully-on phase), the gate voltage of the MOSFET 32 is greater than the power supply voltage Vcc by a threshold voltage or more. The detection circuit 112 outputs an output current to the variable current source 113 based on the voltage difference ΔV, reduces a flow-through current flowing through the charge pump circuit 40, and reduces a boost operation of the charge pump circuit 40.

On the other hand, when the MOSFET 32 is in a turning-on phase, the gate voltage of the MOSFET 32 is less than a value obtained by adding the threshold voltage to the power supply voltage Vcc. The detection circuit 112 outputs an output current to the variable current source 113 based on the voltage difference ΔV, increases a flow-through current, and activates a boost operation of the charge pump circuit 40.

Thus, since the load driving circuit according to the first example includes the detection circuit 112 and the variable current source 113, the flow-through current flowing through the charge pump circuit 40 is changed based on an operating state of the MOSFET 32, that is, based on whether the MOSFET 32 is in a turning-on phase or a fully-on phase, whereby a boost operation of the charge pump circuit 40 is controlled. Namely, by collectively controlling a flow-through current from the oscillation circuit 41 or the buffer 42 included in the charge pump circuit 40, noise that increases in proportion to an amplitude of the flow-through current can be reduced.

Next, the detection circuit and the variable current source will be described. FIG. 2 is a block diagram specifically illustrating the detection circuit and the variable current source.

A detection circuit 112a includes a P-channel depletion type MOSFET 121. The depletion type MOSFET 121 has a source connected to the power supply voltage Vcc, a gate connected to the gate of the MOSFET 32, and a drain connected to the ground via the variable current source 113.

The variable current source 113 includes a current mirror circuit formed by two N-channel MOSFETs 122 and 123. Gates of the N-channel MOSFETs 122 and 123 are connected to each other. The MOSFET 122 has a drain and a gate connected to each other and a source connected to the ground. The MOSFET 123 has a drain connected to the node 51 and a source connected to the ground.

Next, an operation of the MOSFET 32 will be described. A gate voltage of the depletion type MOSFET 121 changes depending on a gate voltage of the MOSFET 32. In this case, the gate voltage of the depletion type MOSFET 121 changes so that the gate voltage is being brought to be equal to the gate voltage of the MOSFET 32.

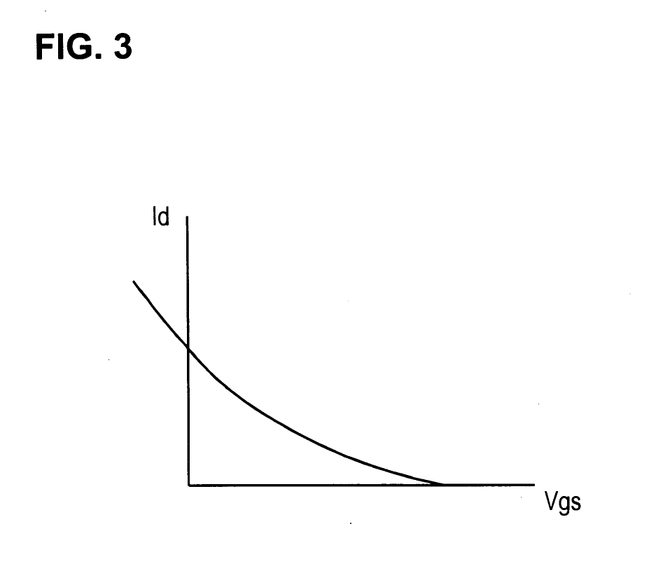

Thus, in a turning-on phase, as the gate voltage of the MOSFET 32 is gradually increased and the N-channel MOSFET 32 is thereby brought in a turning-on phase, a current flowing through the P-channel depletion type MOSFET 121 is decreased conversely as illustrated in FIG. 3. The depletion type MOSFET 121 is configured, so that a desired current Id (a current value that restricts the flow-through current) flows through the depletion type MOSFET 121 when the gate voltage of the MOSFET 32 is high and as the MOSFET 32 is being brought to a fully-on phase.

When a current flowing through the depletion type MOSFET 121 is decreased, a current flowing through the MOSFET 122 is also decreased. Accordingly, the flow-through current flowing through the MOSFET 123 is also decreased.

When the gate voltage of the MOSFET 32 is at a ground potential, a maximum output current flows through the MOSFET 121, the flow-through current flowing through the charge pump circuit 40 is also brought to be maximum, and a sufficient boost (pull up) operation is carried out by the charge pump circuit 40. When the gate voltage of the MOSFET 32 is high and the MOSFET 32 is in a fully-on phase, a minimum output current flows through the depletion type MOSFET 121, the flow-through current flowing through the charge pump circuit 40 is also brought to be minimum, and the boost operation of the charge pump circuit 40 is reduced.

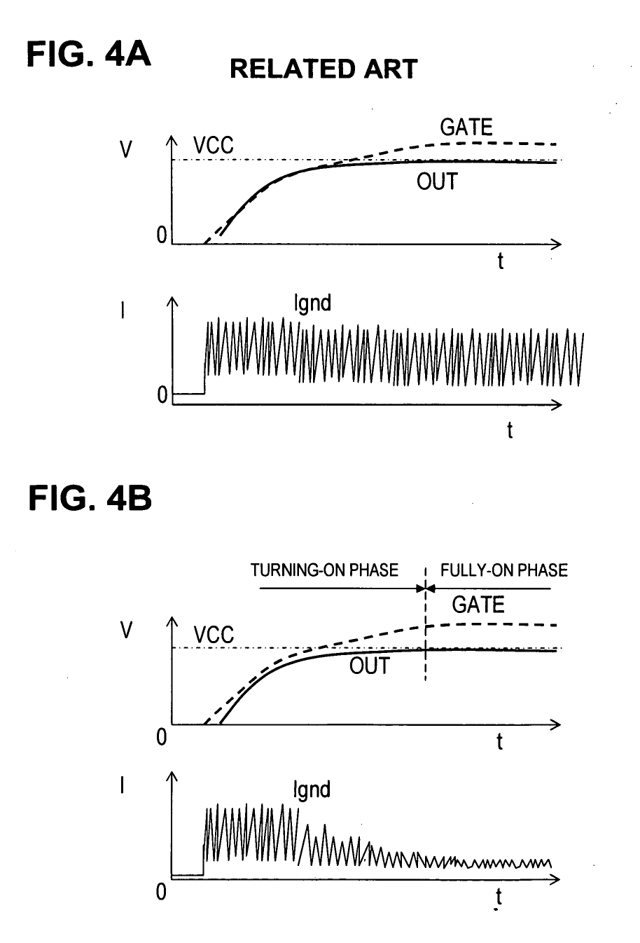

FIG. 4A illustrates a flow-through current and a noise waveform according to a conventional technique, and FIG. 4B illustrates a flow-through current and a noise waveform according to an example of the present invention. In the figures, OUT denotes the source voltage of the MOSFET 32, GATE denotes the gate voltage of the MOSFET 32, and Ignd denotes the flow-through current. In FIG. 4A, regardless of the operating state of the MOSFET 32, the flow-through current of a certain amplitude flows, and the amplitude of the noise is maintained at a certain (high) level. On the other hand, in FIG. 4B, when the MOSFET 32 is brought in a fully-on phase (in a region where the gate voltage is maintained at a certain level), the flow-through current is reduced. Namely, it is seen that, in a fully-on phase, the flow-through current is decreased less than that during the turning-on phase and the amplitude of the noise is also decreased accordingly.

The conventional charge pump circuit always carries out a constant boost operation regardless of whether the output transistor is in a fully-on phase or a turning-on phase. In contrast, the load driving circuit according to the present invention reduces the boost operation when the MOSFET 32 is in a fully-on phase. Thus, since the flow-through current flowing through the charge pump circuit 40 is reduced in a fully-on phase, accordingly, the noise that increases along with the flow-through current can be reduced further.

### Example 2

FIG. 5 is a block diagram of a load driving circuit according to a second example of the present invention. In FIGS. 5 and 2, identical reference characters denote identical elements, and the description thereof will be omitted. A detection circuit 112b includes a P-channel depletion type MOSFET 131, resistive elements 132 and 133, and a diode 134.

The depletion type MOSFET 131 has a source connected to the power supply voltage Vcc, a gate connected to the gate of the MOSFET 32 via the resistive element 132 and to the power supply voltage Vcc via the resistive element 133 and the diode 134 connected in series. Further, the depletion type MOSFET 131 has a drain connected to the ground via the variable current source 113. The diode 134 has a cathode connected to the power supply voltage Vcc and an anode connected to one end of the resistive element 133. When the switch 48 is on, the diode 134 is inversely biased and prevents a leakage current from flowing from the power supply to the ground.

Based on the detection circuit 112b having the above configuration, a voltage difference between the power supply voltage Vcc and the gate voltage of the MOSFET 32 is divided by the resistive elements 132 and 133, and a divided voltage is used to control the depletion type MOSFET 131.

Based on such circuit configuration, the resistive elements 132 and 133 divide a voltage and a divided voltage is used to control the depletion type MOSFET 131. Thus, the second example provides more freedom in the selection of characteristics (FIG. 3) of the depletion type MOSFET 131 than the first example (FIG. 2), counted as an advantage.

### Example 3

FIG. 6 is a block diagram of a load driving circuit according to a third example of the present invention. In FIGS. 6 and 2, identical reference characters denote identical elements, and the description thereof will be omitted. A detection circuit 112c includes a P-channel depletion type MOSFET 141, a resistive element 142, an N-channel depletion type MOSFET 143, and a switch 144.

The depletion type MOSFET 141 has a source connected to the power supply voltage Vcc and a gate connected to the gate of the MOSFET 32 via the resistive element 142 and to the power supply voltage Vcc via the depletion type MOSFET 143. The depletion type MOSFET 141 has a drain connected to the ground via the variable current source 113.

The depletion type MOSFET 143 has a gate and a back gate connected to each other, and the gate and the back gate are also connected to one end of the switch 144. The depletion type MOSFET 143 has a drain connected to the gate of the depletion type MOSFET 141 and one end of the resistive element 142 and a source connected to the power supply voltage Vcc.

The switch 144 is controlled by an external input signal Vin, so that when the load driving circuit is on, the other end of the switch 144 is connected to the power supply voltage Vcc and when the load driving circuit is off, the other end of the switch 144 is connected to the ground. When the load driving circuit is off, namely, when the switch 48 is on, the switch 144 turns off the depletion type MOSFET 143 to prevent a leakage current from flowing from the power supply to the ground.

Based on such circuit configuration, the resistive element 142 and the depletion type MOSFET 143 divide a voltage and a divided voltage is used to control the gate of the depletion type MOSFET 141. Thus, the second example provides more freedom in the selection of characteristics (FIG. 3) of the depletion type MOSFET 141 than the first example (FIG. 2), counted as an advantage.

The entire disclosure of the above Patent Document and the like are incorporated herein by reference thereto. Modifications and adjustments of the exemplary embodiments and examples are possible within the scope of the overall disclosure (including claims) of the present invention and based on the basic technical concept of the invention. In the above examples, the output transistor is exemplified as a MOSFET, but the output transistor is replaceable to other devices such as an IGBT (Insulated Gate Bipolar Transistor). Various combinations and selections of various disclosed elements are possible within the scope of the claims of the present invention. That is, the present invention of course includes various variations and modifications that could be made by those skilled in the art according to the overall disclosure including the claims and the technical concept.

What is claimed is:

1. A load driving circuit comprising:
an output transistor connecting a power supply and a load;
a charge pump circuit boosting a voltage of the power supply and supplying a boosted voltage to a gate of the output transistor;
a detection circuit detecting a voltage difference between the voltage of the power supply and a gate voltage of the output transistor; and
a variable current source controlling a power supply current flowing through the charge pump circuit based on the voltage difference.

2. The load driving circuit according to claim 1,
wherein the output transistor is a transistor of N-channel type, and
wherein, when the detection circuit detects that the gate voltage of the output transistor exceeds the voltage of the power supply by a predetermined value, the variable current source reduces the power supply current.

3. The load driving circuit according to claim 1,
wherein, when the power supply current is reduced, the charge pump circuit reduces a boost operation, and
wherein, when the power supply current is increased, the charge pump circuit activates a boost operation.

4. The load driving circuit according to claim 1,
wherein the detection circuit comprises a PMOS transistor having a source connected to the power supply, a gate connected to the gate of the output transistor, and a drain connected to one end of the variable current source, and
wherein the variable current source comprises a current mirror circuit having one end connected to the drain of the PMOS transistor and the other end connected to the charge pump circuit.

5. The load driving circuit according to claim 4, wherein the PMOS transistor is a depletion type transistor.

6. The load driving circuit according to claim 4, wherein the detection circuit further comprises:
a first resistive element between the gate of the PMOS transistor and the gate of the output transistor; and
a series circuit comprising a diode forward biased when a current flows from the gate of the PMOS transistor to the power supply and a second resistive element between the gate of the PMOS transistor and the power supply.

7. The load driving circuit according to claim 4, wherein the detection circuit further comprises:
a first resistive element between the gate of the PMOS transistor and the gate of the output transistor;
a detection and control NMOS transistor between the gate of the PMOS transistor and the power supply; and
a switch connecting a gate of the detection and control NMOS transistor to the power supply or the ground.

8. The load driving circuit according to claim 7, wherein the detection and control NMOS transistor is a depletion type transistor.

9. The load driving circuit according to claim 1,
wherein the output transistor is a MOS transistor of the first conductivity type, and
wherein, when the detection circuit detects that the gate voltage of the output transistor exceeds the voltage of the power supply by a predetermined value, the variable current source reduces the power supply current.

10. The load driving circuit according to claim 9,
wherein, when the power supply current is reduced, the charge pump circuit reduces a boost operation, and
wherein, when the power supply current is increased, the charge pump circuit activates a boost operation.

11. The load driving circuit according to claim 9,
wherein the detection circuit comprises a MOS transistor of the second conductivity type having a source connected to the power supply, a gate connected to the gate of the output transistor, and a drain connected to one end of the variable current source, and
wherein the variable current source comprises a current mirror circuit having one end connected to the drain of the MOS transistor of the second conductivity type and the other end connected to the charge pump circuit.

12. The load driving circuit according to claim 11, wherein the MOS transistor of the second conductivity type is a depletion type transistor.

13. The load driving circuit according to claim 12, wherein the detection circuit further comprises:
a first resistive element between the gate of the MOS transistor of the second conductivity type and the gate of the output transistor; and
a series circuit comprising a diode forward biased when a current flows from the gate of the MOS transistor of the second conductivity type to the power supply and a second resistive element between the gate of the MOS transistor of the second conductivity type and the power supply.

14. The load driving circuit according to claim 12, wherein the detection circuit further comprises:
a first resistive element between the gate of the MOS transistor of the second conductivity type and the gate of the output transistor;
a detection and control MOS transistor of the first conductivity type between the gate of the MOS transistor of the second conductivity type and the power supply; and
a switch connecting a gate of the detection and control MOS transistor to the power supply or the ground.

15. The load driving circuit according to claim 14, wherein the detection and control MOS transistor is a depletion type transistor.

16. The load driving circuit according to claim 9, wherein said MOS transistor of the first conductivity type comprises a NMOS transistor.

17. The load driving circuit according to claim 11, wherein said MOS transistor of the second conductivity type comprises a PMOS transistor.
